(19) United States
(12) Patent Application Publication
(10) Pub. No.: US 2025/0130418 A1
(43) Pub. Date: Apr. 24, 2025

(54) DEFORMABLE MEMBRANES

(71) Applicant: TRANSCELESTIAL TECHNOLOGIES PTE LTD, Singapore (SG)

(72) Inventors: Mohammad DANESH, Singapore (SG); Quentin BAUDENON, Salles d’Aude (FR)

(73) Assignee: TRANSCELESTIAL TECHNOLOGIES PTE LTD, Singapore (SG)

(21) Appl. No.: 18/681,506

(22) PCT Filed: Aug. 5, 2021
(86) PCT No.: PCT/IB2021/057232

§ 371 Date: Feb. 5, 2024

(51) Int. Cl. G02B 26/08; G02B 6/42

(52) U.S. Cl. CPC G02B 26/0825; G02B 6/4214; G02B 6/4226; G02B 6/4246

(57) ABSTRACT

The present disclosure generally relates to deformable diaphragms. More particularly, but not exclusively, the present disclosure relates to deformable diaphragms which include a mirror component and may be used for steering optical signals such as light or laser beams. In one form, a device includes a conductive substrate, a rigid mirror positioned on a first side of the conductive substrate, a piezoelectric material positioned on a second side of the conductive substrate, and a plurality of electrodes positioned on the piezoelectric material. In one aspect of this form, the conductive substrate is flexibly deformable in response to application of an electrical potential to one or more of the electrodes positioned on the piezoelectric material to move the mirror.

### FIELD

The present disclosure generally relates to deformable diaphragms. More particularly, but not exclusively, the present disclosure relates to deformable diaphragms which include a mirror component and may be used for steering optical signals such as light or laser beams.

### BACKGROUND

Unless otherwise indicated herein, the materials described herein are not prior art to the claims in the present application and are not admitted to be prior art by inclusion in this section.

Components for directional steering of optical signals such as light or laser beams may be utilized in a number of different applications. In one form for example, a component may include a mirror which is positioned in a beam path of a light or laser beam such that the light or laser beam may be directed onto a surface of the mirror, and the mirror may change the incoming direction of the laser and direct the laser beam to an intended target downstream of the mirror. When the downstream target is a single target, or the light or laser beam directed onto the mirror is relatively steady, the mirror may be static in nature.

In some forms however, it may be desired to direct the laser beam toward a number of intended targets downstream of the mirror or otherwise alter the direction of the light or laser beam in more than one manner. Additionally or alternatively, there may be angular fluctuations in the light or laser beam directed at the mirror, and the angular fluctuations may be induced by the transceiver which provides the light or laser beam. For example, in a point to point laser communication link where the laser is used to transmit data between two or more points, these fluctuations could be caused by atmospheric turbulence causing the laser beam to wander in random directions or could be caused by vibrations or movements in either side of the link. In some cases the transmitter and/or receiver may also be moving or vibrating out of alignment. In these forms, the mirror must be dynamic in nature or, stated alternatively, movable in one or more directions to properly direct the laser beam to an intended downstream target or otherwise alter the direction of the laser beam. A number of different approaches have been employed for moving a mirror. For example, motorized mirror mounts, voice coil actuated mirrors, MEMS micro-mirrors and unimorph deformable mirrors may be used. However, these approaches may be bulky, slow, provide imprecise control, consume high amounts of energy, suffer from high costs or durability issues, and/or distort the light or laser beam received by the mirror.

In view of the foregoing, there is a need for additional contributions in this area of technology.

The subject matter claimed herein is not limited to implementations that solve any disadvantages or that operate only in environments such as those described above. Rather, this background is only provided to illustrate one example technology area where some implementations described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In one example embodiment, a device includes a conductive substrate; a rigid mirror positioned on a first side of the conductive substrate; a piezoelectric material positioned on a second side of the conductive substrate; and a plurality of electrodes positioned on the piezoelectric material. The conductive substrate is flexibly deformable in response to application of an electrical potential to one or more of the electrodes positioned on the piezoelectric material to move the mirror.

In another embodiment, an apparatus includes a substrate; a mirror coupled to a first side of the substrate; a piezoelectric material positioned on a second side of the substrate; a number of electrodes coupled to the piezoelectric material; and an electrical driver electrically coupled to the electrodes. The mirror exhibits sufficient rigidity for resisting deformation in response to deformation of the substrate in response to application of an electrical potential from the electrical driver to one or more of the electrodes.

In yet another embodiment, a method includes providing a device including a conductive substrate having a first configuration, a mirror coupled to a first side of the conductive substrate and having a first configuration, and a number of electrodes coupled to a second side of the conductive substrate. The method also includes applying an electrical potential to one or more of the electrodes coupled to the second side of the conductive substrate to deform the conductive substrate relative to the first configuration of the conductive substrate and move the mirror while maintaining the mirror in the first configuration of the mirror.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of deformable diaphragm;

FIG. 2 is an alternative perspective view of the deformable diaphragm of FIG. 1;

FIG. 3 is a side view of the deformable diaphragm of FIG. 1;

FIGS. 4A and 4B are top and bottom views, respectively, of an alternative embodiment deformable diaphragm;

FIGS. 5A and 5B are top and bottom views, respectively, of an another alternative embodiment deformable diaphragm;

FIGS. 6A and 6B are top and bottom views, respectively, of yet another alternative embodiment deformable diaphragm;

FIGS. 7A-E are schematic illustrations of the deformable diaphragm of FIG. 1 with or without an electrical potential applied to various electrodes; and

FIGS. 8A-C are schematic illustrations of the deformable diaphragm of FIG. 1 illustrating its configuration with or without an electrical potential applied to various electrodes.

### DETAILED DESCRIPTION

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

The present disclosure generally relates to deformable diaphragms. More particularly, but not exclusively, the present disclosure relates to deformable diaphragms which include a mirror component and may be used for steering optical signals such as light or laser beams. In one aspect, the mirror component may be moved without any change or deformation to its configurations. Although various embodiments are described in the context of components which may be used in the field of directing or steering optical signals such as light or laser beams, the embodiments disclosed herein may be employed in other fields or operating environments where the functionality disclosed herein may be useful. Accordingly, the scope of the invention should not be construed to be limited to the example implementations and operating environments disclosed herein.

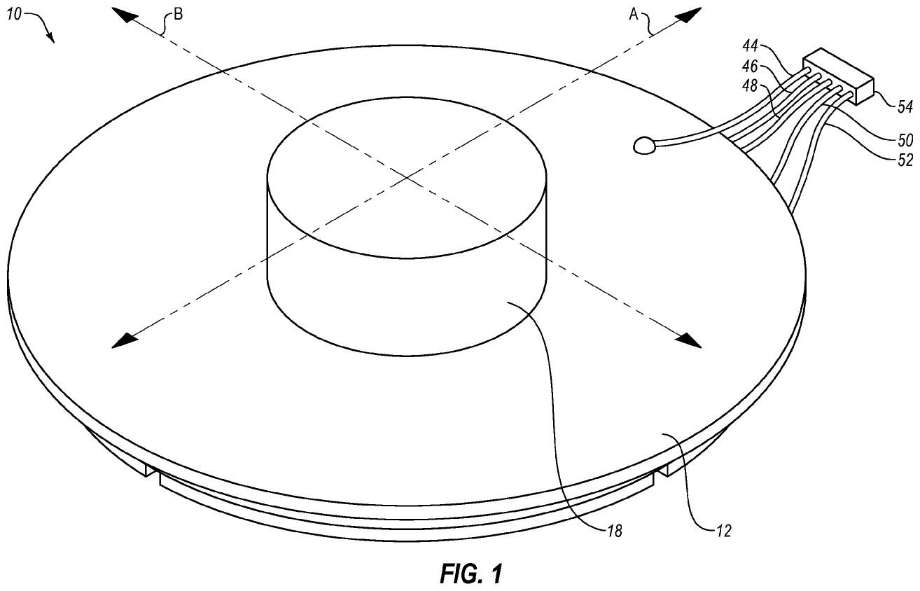

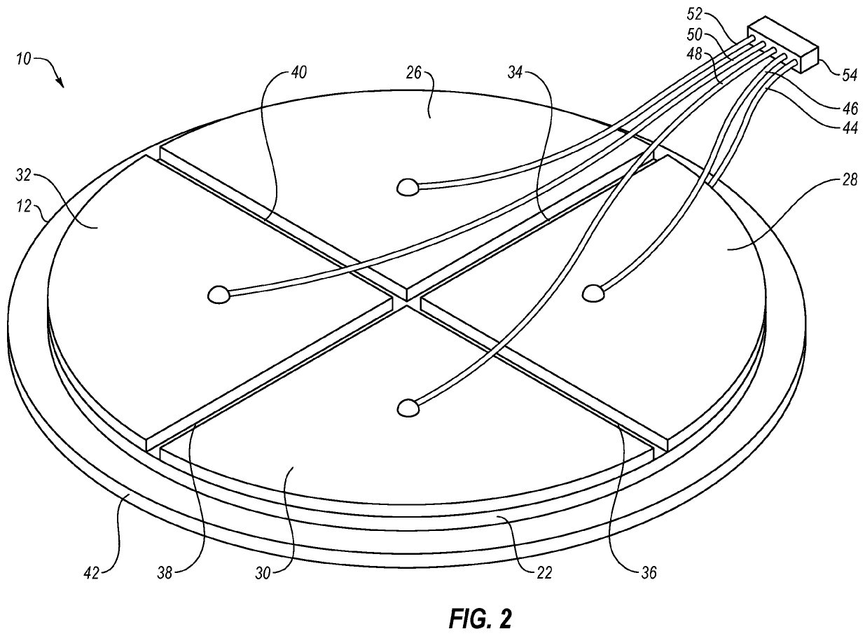

With general reference to FIGS. 1-3 for example, a deformable diaphragm 10 includes a substrate 12 having a first side or surface 14 positioned opposite of a second side or surface 16. In the illustrated form, the substrate 12 includes a generally circular configuration, although variations in the configuration or shape of the substrate 12 are possible. Generally speaking, the substrate 12 may be formed of a flexibly deformable material. In one non-limiting form, the substrate 12 is formed of a flexibly deformable conductive material, non-limiting examples of which include metallic materials and conductive polymer materials. The metallic materials may include, but are not limited to including, brass, copper, aluminum and mixtures thereof.

The device 10 also includes a mirror 18 which is positioned on or otherwise coupled to the first side 14 of the substrate 12. The mirror 18 may be coupled to the substrate 12 in any suitable fashion, including through the use of one or more adhesives. The mirror 18 may also be coupled to the substrate 12 utilizing anodic bonding, eutectic bonding, surface activated bonding, plasma activated bonding, glass frit bonding, and/or reactive bonding, just to provide a few non-limiting examples. In one form, the mirror 18 may be an optical-grade mirror for example. In this or another form, the mirror 18 may be structured to resist deformation in response to deformation of the substrate 12. For example, the mirror 18 have stiffness or structural rigidity sufficient for resisting deformation of the mirror 18 when the substrate 12 is deformed. Similarly, in this arrangement, the mirror 18 may include a flat surface upon which the light or laser beam may be directed, and this surface may remain flat even when the substrate 12 is deformed.

A piezoelectric material is deposited in layer 22 on the second side of the substrate 12. The piezoelectric material may be crystalline, ceramic or polymeric. In some more particular but non-limiting forms, the piezoelectric material may include one or more of lead zirconate titanate, barium titanite, lead titanite, gallium nitride, zinc oxide, aluminium nitride, and lithium niobate. A layer 24 of conductive material is deposited on the layer 22 of the piezoelectric material. The conductive material of the layer 24 is deposited in a pattern providing a number of segmented electrodes. More specifically, in the form illustrated in FIGS. 1-3 for example, the device 10 includes electrodes 26, 28, 30 and 32. While the device 10 includes four electrodes in the illustrated form, it is contemplated that a different number of electrodes could be provided. For example, forms in which the device 10 includes one, two, three, or more than four electrodes are also possible depending on the desired functionality of the device 10, further details of which will be provided below.

Each of the electrodes 26, 28, 30 and 32 is separated from one another such that each of the electrodes 26, 28, 30 and 32 is isolated from the others of the electrodes 26, 28, 30 and 32. For example, a space 34 exposing the layer 22 of the piezoelectric material is positioned between the electrode 26 and the electrode 28; a space 36 exposing the layer 22 of the piezoelectric material is positioned between the electrode 28 and the electrode 30; a space 38 exposing the layer 22 of the piezoelectric material is positioned between the electrode 30 and the electrode 32; and a space 40 exposing the layer 22 of the piezoelectric material is positioned between the electrode 32 and the electrode 26. The spaces 34, 36, 38 and 40 intersect with one another at or near a center of the substrate 12. In addition, a ring 42 exposing the layer 22 of the piezoelectric material extends about the electrodes 26, 28, 30 and 32. Forms in which the ring 42 is not present are also contemplated and possible.

A number of electrical leads 44, 46, 48, 50 and 52 are coupled to and extend from the device 10 and terminate at a connector 54 which may be configured for engagement with an electrical driver. The electrical lead 44 is coupled to the substrate 12 on the first side 14 thereof, the electrical lead 52 is coupled to the electrode 26, the electrical lead 50 is coupled to the electrode 32, the electrical lead 48 is coupled to the electrode 30, and the electrical lead 46 is coupled to the electrode 28. It should be understood that the number of electrical leads present may vary depending on the number of electrodes positioned on the layer 22 of the piezoelectric material. For example, if there are three electrodes present, then the device may include four electrical leads, one being coupled to the substrate 12 and the others being coupled to the electrodes. While not previously discussed, the electrical leads 44, 46, 48, 50 and 52 may be coupled to the substrate 12 and the electrodes 26, 28, 30 and 32 through any suitable manner, including for example through the use of a soldered connection, conductive epoxy or any other wire-bonding method. In one form, the electrical leads 46, 48, 50 and 52 may be used to provide an electrical potential to one or more of the electrodes 26, 28, 30 and 32 and the electrical lead 44 coupled to the substrate 12 may provide a grounding source or another electrical potential to the substrate 12.

As will be discussed in greater detail below, application of an electrical potential to one or more of the electrodes 26, 28, 30 and 32 results in a deformation in the piezoelectric material of layer 22, thereby generating deformation or actuation of the substrate 12 in one or more directions. For example, the piezoelectric material may generate local stress over a reverse piezoelectric effect in the substrate 12 that leads to its deformation.

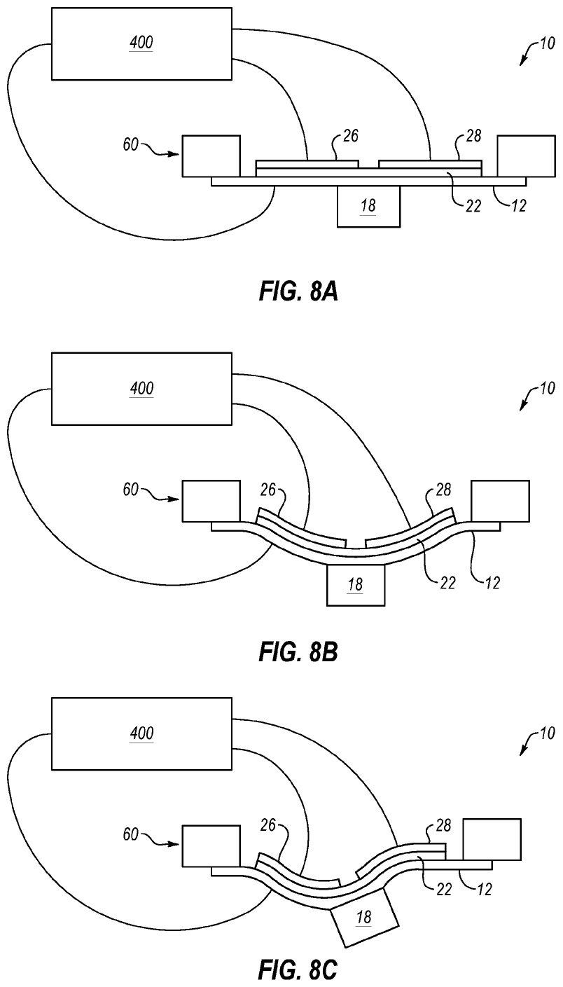

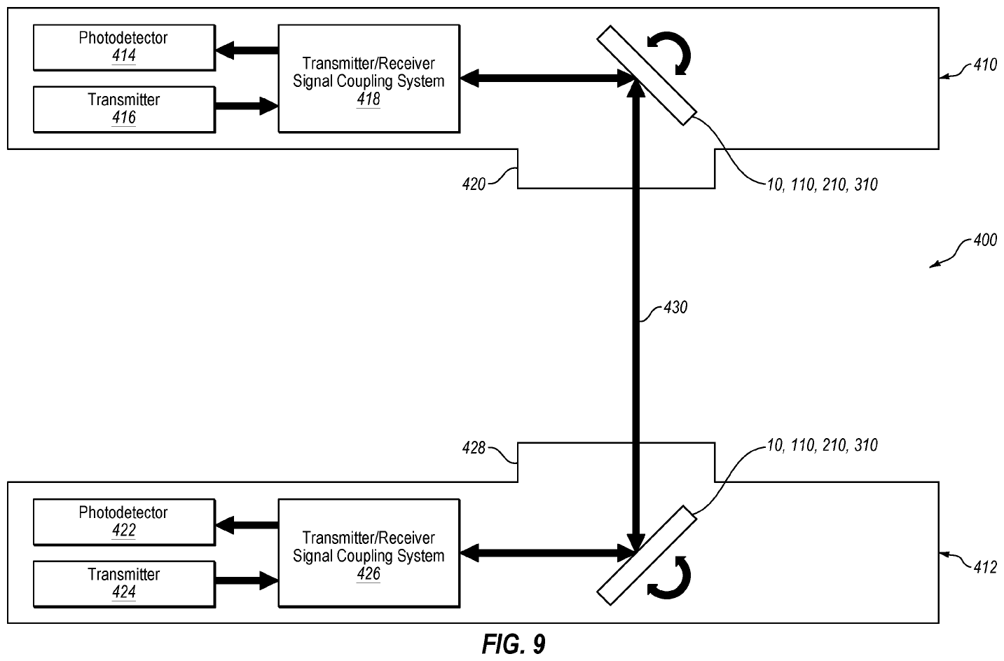

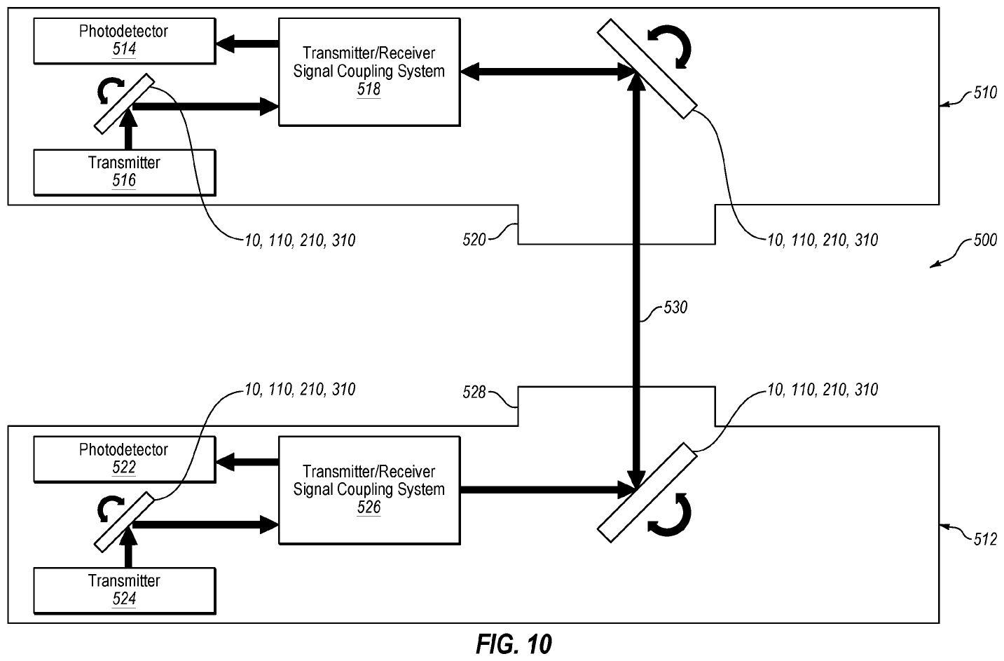

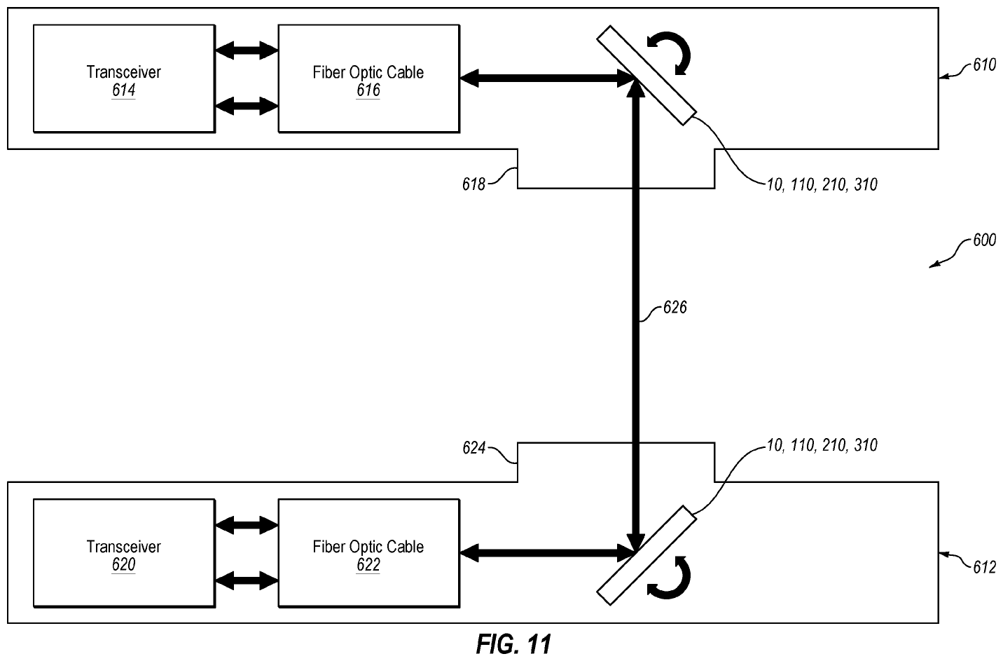

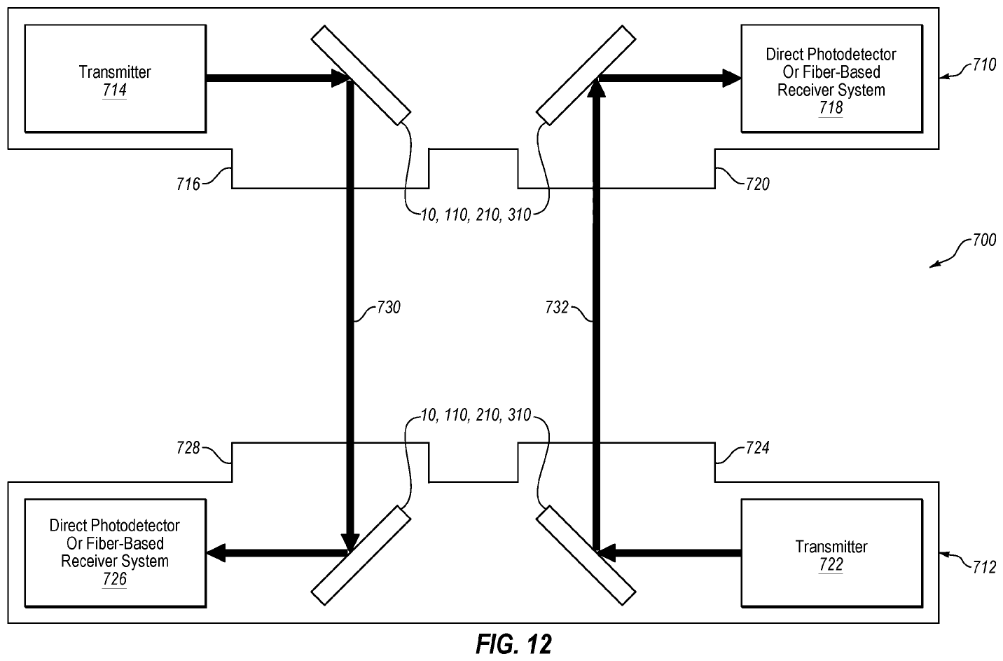

While not previously described, the device 10 may be positioned in or otherwise engaged with a holder (schematically illustrated in FIGS. 8A-C for example) which engages with all or a portion of the outer edge or an outer portion of the substrate 12. In some forms, the holder may engage with the first surface 14, the second surface 16, or both the first surface 14 and the second surface 16. By way of example, when the holder engages with the first surface 14 and the second surface 16, it may include opposing pieces between which the substrate 12 may be clamped in an arrangement maintaining a configuration of the surface by compression. The holder may generally prevent deformation along the outer edge or outer portion of the substrate 12 such that the central portion of the substrate 12 is actuated or deformed relative to its outer edge or outer portion. For example, the holder may exhibit structural rigidity sufficient for resisting deformation when the substrate 12 is flexibly deformed in response to application of the electrical potential to one or more of the electrodes 26, 28, 30 and 32. In one non-limiting form, the holder may be defined by a rigid ring having a hollow interior, and the substrate 12 may be coupled to the rigid ring with the substrate 12 positioned in the hollow interior. For example, the substrate 12 may be coupled to the rigid ring through any form of bonding, including for example through the use of adhesives, and/or the rigid ring may include opposing pieces between which the substrate may be clamped in a manner similar to that described above. In this form, the hollow interior may provide access to the electrodes the electrodes 26, 28, 30 and 32, and the electrical leads 46, 48, 50 and 52 may extend through the hollow interior of the rigid ring.

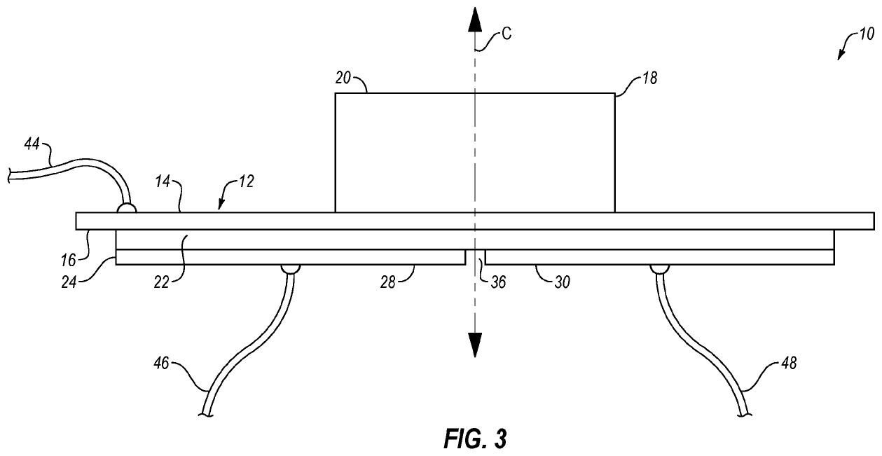

As the substrate 12 is deformed, the mirror 18 may in turn be moved in one or more directions. For example, the mirror 18 may be tilted in either direction along the axis represented by directional arrow A shown in FIG. 1, tipped in either direction along the axis represented by the directional arrow B shown in FIG. 1, translated along the axis of the directional arrow C shown in FIG. 3, or moved in a combination of two or more of these directions. In this latter instance, it should be appreciated that the mirror may be moved in one or more directions positioned between the directional arrows A and B. As indicated above, the mirror 18 may be structured such that deformation thereof is prevented when the substrate 12 is deformed. Similarly, the shape and configuration of the mirror 18 may be maintained even as it moved due to the deformation of the substrate 12. In one aspect for example, the surface of the mirror 18 upon which a light or laser beam may be directed may be flat, and the surface may remain flat even as the mirror 18 is moved due to the deformation of the substrate 12.

In the form illustrated in FIGS. 1-3, the substrate 12 may have a generally solid configuration. In this form, the movement of the mirror 18 effectuated by deformation of the substrate 12 may be at least partially dependent on any one or more of: the flexibility of the material from which the substrate 12 is formed; the thickness and/or shape of the substrate 12; the size, shape and the specific material of the piezoelectric material in the layer 22; the size, shape and positioning of the electrodes on the layer 22 of the piezoelectric material; the voltage range and resolution of the electrodes positioned on the layer 22 of the piezoelectric material; the number of the electrodes to which the electrical potential is applied; the amount of the applied electrical potential; and the size and weight of the mirror 18, although other variations and factors are also contemplated. Variation of any one or more of these factors may facilitate, for example, adjustments (or a range of adjustments) to the resolution, range, and responsiveness of the device 10, amongst other characteristics and attributes of the device 10.

In addition to the above factors relating to the movability of the mirror 18 due to deformation of the substrate 12, the substrate 12 may be provided with one or more physical features which also affect its deformation and, in turn, how the mirror 18 is moved when the substrate 12 is deformed. For example, the substrate 12 may include one or more flexures which may affect (e.g., increase or decrease) the range of deformation or actuation of the substrate 12 and, in turn, alter (e.g., increase or decrease) the range of movement of the mirror 18 induced by deformation of the substrate 12.

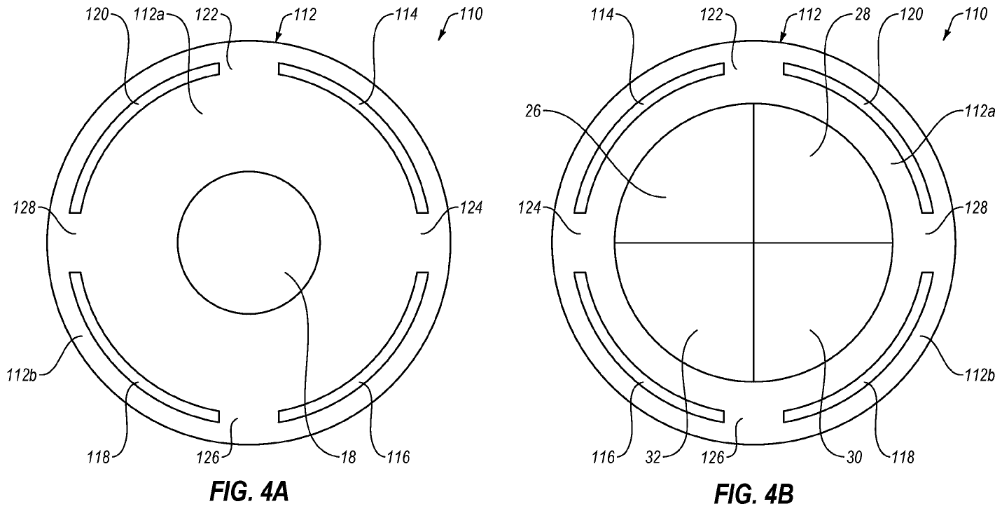

With general reference to FIGS. 4A and 4B for example, where like numerals refer to like features previously described, a deformable diaphragm 110 includes a substrate 112 having an inner portion 112a and an outer portion 112b which in the illustrated form is in the configuration of a ring surrounding the inner portion 112a. A number of arcuate openings 114, 116, 118 and 120 are positioned between the inner portion 112a and the outer portion 112b and extend through the substrate 112. In one form, the inner portion 112a and the outer portion 112b are formed from the same material such that the substrate 112 has a monolithic structure or, stated alternatively, there are no joints between the inner portion 112a and the outer portion 112b and these components are integral with one another. In other variations, the inner portion 112a and the outer portion 112b may be separate components which are joined or otherwise coupled to one another. In these forms, the inner portion 112a and the outer portion 112b may be formed of the same or different materials. When the inner portion 112a and the outer portion 112b are formed of different materials, the material from which the inner portion 112a is formed may exhibit greater flexibility than the material from which the outer portion 112b is formed, or vice versa.

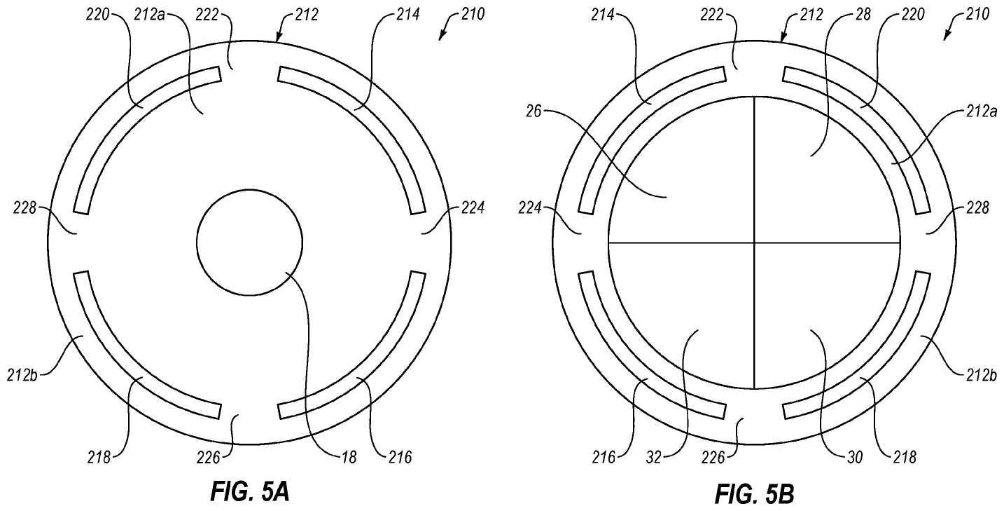

In the device 110, the arcuate openings 114, 116, 118 and 120 may cooperate to define a plurality of flexures 122, 124, 126 and 128 which extend from the inner portion 112a to the outer portion 112b of the substrate 112. The flexures 122, 124, 126 and 128 have a generally rectangular configuration and may provide a greater range of actuation or deformation of the inner portion 112a relative to forms where the flexures 122, 124, 126 and 128 are not present. In one aspect, when the substrate 112 is positioned in or otherwise engaged with a holder which engages with all or a portion of the outer edge or an outer portion of the substrate 112, the inner portion 112a may be actuated or deformed at or along one or more of the flexures 122, 124, 126 and 128, amongst other possible locations, as the holder prevents actuation or deformation of the outer portion 112b of the device 110. In FIGS. 5A and 5B, where like numerals refer to like features previously described, a deformable diaphragm 210 includes a substrate 212 having an inner portion 212a and an outer portion 212b which in the illustrated form is in the configuration of a ring surrounding the inner portion 212a. A number of arcuate openings 214, 216, 218 and 220 are positioned between the inner portion 212a and the outer portion 212b and extend through the substrate 212. In one form, the inner portion 212a and the outer portion 212b are formed from the same material such that the substrate 212 has a monolithic structure or, stated alternatively, there are no joints between the inner portion 212a and the outer portion 212b and these components are integral with one another. In other variations, the inner portion 212a and the outer portion 212b may be separate components which are joined or otherwise coupled to one another. In these forms, the inner portion 212a and the outer portion 212b may be formed of the same or different materials. When the inner portion 212a and the outer portion 212b are formed of different materials, the material from which the inner portion 212a is formed may exhibit greater flexibility than the material from which the outer portion 212b is formed, or vice versa.

In the device 210, the arcuate openings 214, 216, 218 and 220 may cooperate to define a plurality of flexures 222, 224, 226 and 228 which extend from the inner portion 212a to the outer portion 212b of the substrate 212. The flexures 222, 224, 226 and 228 have a generally triangular configuration and may provide a greater range of actuation or deformation of the inner portion 212a relative to forms where the flexures 222, 224, 226 and 228 are not present. In one aspect, when the substrate 212 is positioned in or otherwise engaged with a holder which engages with all or a portion of the outer edge or an outer portion of the substrate 212, the inner portion 212a may be actuated or deformed at or along one or more of the flexures 222, 224, 226 and 228, amongst other possible locations, as the holder prevents actuation or deformation of the outer portion 212b of the device 210.

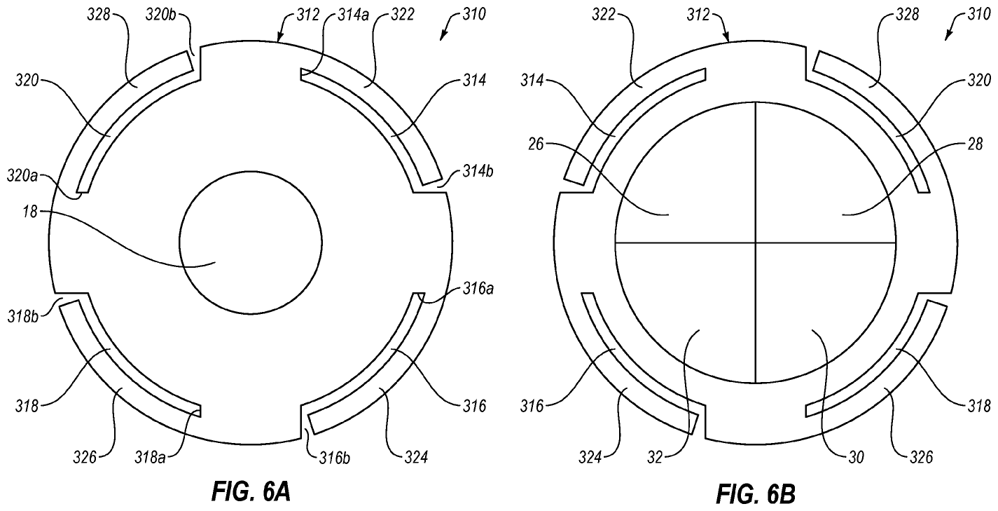

In FIGS. 6A and 6B, where like numerals refer to like features previously described, a deformable diaphragm 310 includes a substrate 312. A number of arcuate openings or grooves 314, 316, 318 and 320 are formed in the substrate 312. The arcuate openings 314, 316, 318 and 320 extend through the substrate 312 and include a closed end 314a, 316a, 318a, and 320a, respectively, disposed inwardly of an outer edge of the substrate 312. The arcuate openings 314, 316, 318 and 320 also respectively include an open end 314b, 316b, 318b and 320b which opens at or along an outer edge of the substrate 312.

In the illustrated form, the arcuate openings 314, 316, 318 and 320 cooperate to define a plurality of flexures 322, 324, 326 and 328 which are integrally formed with the remaining portion of the substrate 312. The flexures 322, 324, 326, and 328 are generally configured as elongated arcuate strips and include a free end given the open ends 314b, 316b, 318b, and 320b of the arcuate openings 314, 316, 318 and 320. Generally speaking, the flexures 322, 324, 326, and 328 may provide a greater range of actuation or deformation of the substrate 312 relative to forms where the flexures 322, 324, 326, and 328 are not present. In one aspect, when the substrate 312 is positioned in or otherwise engaged with a holder which engages with all or a portion of the outer edge or an outer portion of the substrate 312, the substrate 312 may be actuated or deformed at or along one or more of the flexures 322, 324, 326, and 328, amongst other possible locations, as the holder prevents actuation or deformation of the outer portion of the substrate 312.

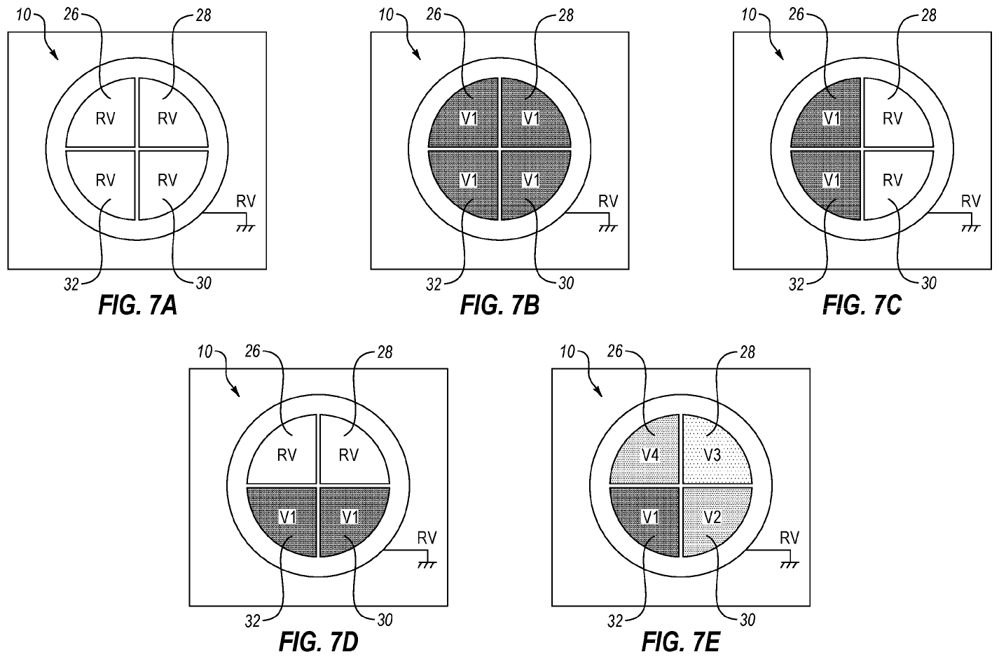

FIGS. 7A-E provide schematic illustrations of different non-limiting scenarios for the application, or non-application, of an electric potential to one or more of the electrodes 26, 28, 30 and 32 of the device 10, while FIGS. 8A-C schematically illustrate an apparatus including the device 10 and an electrical driver 400. FIGS. 8A-C are also representative of non-limiting configurations of the substrate 12 dependent on if, and to what electrodes, the electrical potential is applied. While the illustrations in these Figures and the following description relate to the device 10, it should be understood that the following description is also applicable to operation or functionality of the devices 110, 210 and 310.

In FIG. 7A for example, an electrical potential has not been applied to any of the electrodes 26, 28, 30 and 32 of the device 10, as represented by the RV (reference voltage) designation on the electrodes 26, 28, 30 and 32. Similarly, as illustrated in FIG. 8A, the substrate 12, which is coupled to a holder 60, remains in its natural or undeformed configuration, which is generally flat or linear. It should be understood that the substrate 12, after deformation following application of an electrical potential, may also return to the configuration illustrated in FIG. 8A when application of the electrical potential is ceased.

In FIG. 7B, an electrical potential has been applied to each of the electrodes 26, 28, 30 and 32 of the device 10. In the illustrated form, the electrical potential applied to each of the electrodes 26, 28, 30 and 32 is shown to be the same; however forms where the electrical potential applied to each of the electrodes 26, 28, 30 and 32 is different may also be possible. When an electrical potential is applied in the illustrated manner, a deformation occurs in the piezoelectric material, generating deformation or actuation of the substrate 12 in a manner which results in translation of the mirror 18 along the axis or direction of the directional arrow C shown in FIG. 3. This configuration is illustrated in FIG. 8B, where the substrate 12 has been deformed or actuated and the mirror 18 has been moved away from the holder 60 relative to the configuration illustrated in FIG. 8A. However, the configuration of the mirror 18 remains the same in FIGS. 8A and 8B regardless of the deformation of the substrate 12.

In FIG. 7C, an electrical potential has been applied to each of the electrodes 26 and 32 of the device 10, but not to the electrodes 28 and 30 as represented by the RV (reference voltage) designation on these electrodes. In the illustrated form, the electrical potential applied to each of the electrodes 26 and 32 is shown to be the same; however forms where the electrical potential applied to each of the electrodes 26 and 32 is different may also be possible. When an electrical potential is applied in the illustrated manner, a deformation occurs in the piezoelectric material, generating deformation or actuation of the substrate 12 in a manner which results in tipping of the mirror 18 along the axis or direction of the directional arrow B shown in FIG. 1. This configuration is illustrated in FIG. 8C, where the substrate 12 has been deformed or actuated and the mirror 18 has been tipped relative to the holder 60 as compared to the configuration illustrated in FIG. 8A. However, the configuration of the mirror 18 remains the same in FIGS. 8A and 8C regardless of the deformation of the substrate 12.

In FIG. 7D, an electrical potential has been applied to each of the electrodes 30 and 32 of the device 10, but not to the electrodes 26 and 28 as represented by the RV (reference voltage) designation on these electrodes. In the illustrated form, the electrical potential applied to each of the electrodes 30 and 32 is shown to be the same; however forms where the electrical potential applied to each of the electrodes 30 and 32 is different may also be possible. When an electrical potential is applied in the illustrated manner, a deformation occurs in the piezoelectric material, generating deformation or actuation of the substrate 12 in a manner which results in tilting of the mirror 18 along the axis or direction of the directional arrow A shown in FIG. 1.

In FIG. 7E, an electrical potential has been applied to each of the electrodes 26, 28, 30 and 32. In the illustrated form, the electrical potential applied to each of the electrodes 26 and 30 is shown to be the same while the electrical potential applied to each of the electrodes 28 and 32 is different from that applied to the other electrode and to the electrical potential applied to the electrodes 26 and 30; however variations in the electrical potential applied to the various electrodes may also be possible. When an electrical potential is applied in the illustrated manner, a deformation occurs in the piezoelectric material, generating deformation or actuation of the substrate 12 in a manner which results in tilting of the mirror 18 along the axis or direction of the directional arrow A shown in FIG. 1, tipping of the mirror along the axis or direction of the directional arrow B shown in FIG. 1, and translation of the mirror 18 along the axis or direction of the directional arrow C shown in FIG. 3.

In view of the foregoing, non-limiting examples, it should be understood that the application of electrical potential to different electrodes, and possibly in different amounts to different electrodes, may result in a variety of different actuations or deformations of the substrate 12 and, in turn, movements of the mirror 18. However, as illustrated in FIGS. 8B and 8C for example, as the mirror 18 is moved in response to the actuation or deformation of the substrate 12, it maintains its original shape and configuration shown in FIG. 8A. In one aspect for example, the mirror 18 may exhibit greater stiffness or rigidity than the substrate 12 such that the substrate 12 may deform without deformation of the mirror 18, as noted above.

While not previously noted, it should be understood that the electrical driver 400 may be configured to provide different electrical potentials to different electrodes in order to effectuate a desired movement of the mirror 18. In addition, in light of the description provided in connection with FIGS. 7A-E for example, forms in which the device 10 includes fewer than four electrodes when, for example, movement of the mirror 18 is only needed in one or two directions.

The subject matter disclosed herein may be used in a number of different applications, including but not limited to, beam steering and beam scanning as a fine steering mirror in free-space optical systems. As another example, the subject matter disclosed herein may be used in consumer electronic systems where it may be employed as an actuator for digital and scanning laser projectors, overhead displays, augmented reality glasses, three dimensional (3D) imaging systems and Lidars. As yet another example, the subject matter disclosed herein may be used in the telecommunication sector, where it may be employed for example in optical switches and optical cross connects. In other forms, the subject matter disclosed herein may be used in precision machining, maskless lithography, 3D printing and laser cutting. In still another example, the subject matter disclosed herein may be used in free space communication systems or astronomical adaptive optics systems to compensate for any phenomenon, such as vibrations or scintillation, that would steer a light or laser beam away from an intended target.

In one form, where a mirror is moved in translation along axis C, it may be considered a “piston-type mirror”. Generally speaking, mirrors of this nature may be used in applications which involve changing the phase of a reflected optical beam. More particular but non-limiting examples of devices which may utilize mirrors of this form include spectrometers, interferometers, optical phased arrays, tunable lasers and optical filters.

The subject matter disclosed herein may also be used in both open-loop and closed-loop modes. Various feedback signals can be used, including but not limited to the received power of a photodetector, array of photodetectors, quadrant photodetector or camera, either by direct illumination or after free space to fiber coupling.

As indicated above, in some point to point laser communication link systems where a laser is used to transmit data between two or more points (such as in a free-space optical system), angular fluctuations in the laser may be induced by the transceiver which provides the light or laser beam and/or could be caused by atmospheric turbulence causing the laser beam to wander in random directions or could be caused by vibrations or movements in either side of the link. In some cases the transmitter and/or receiver may also be moving or vibrating out of alignment. In one non-limiting form, one or more of the diaphragms 10, 110, 210 and 310 disclosed herein may be used to realign the transmitted and/or received light for optimal alignment on the receiver sensor such as a photodetector or fiber optic cable. In some cases where the system is fully duplex and each side has at least one transmitter and one or more receivers, one or more of the diaphragms 10, 110, 210 and 310 may be needed to realign and optimize the light paths to be either sent accurately to the other point and/or align the light precisely on to the receiver. In some case where one of the sides is moving very fast in relation to the other the diaphragm 10, 110, 210 or 310 could be used to perform a point ahead function where the light transmitted out is sent in a slightly different direction than the received light to account for the relative movement and limited speed of light travelling through the atmosphere.

A schematic illustration of one form of a free space communication system 400 in which one or more of the diaphragms 10, 110, 210 and 310 may be utilized is illustrated in FIG. 9. The system 400 includes a first point to point laser communication device 410 and a second point to point laser communication device 412. The first point to point laser communication device 410 includes a photodetector 414, a transmitter 416, a transmitter/receiver signal coupling system 418, one of the diaphragms 10, 110, 210 and 310 described herein, and a telescope 420. The diaphragm 10, 110, 210 or 310 is positioned between the transmitter/receiver signal coupling system 418 and the telescope 420. The second point to point laser communication device 412 includes a photodetector 422, a transmitter 424, a transmitter/receiver signal coupling system 426, one of the diaphragms 10, 110, 210 and 310 described herein, and a telescope 428. The diaphragm 10, 110, 210 or 310 is positioned between the transmitter/receiver signal coupling system 426 and the telescope 428. In the system 400, one or more laser beams 430 may be transmitted between the first and second point to point laser communication devices 410 and 412 to transmit information therebetween, and a propagation medium between the first and second point to point laser communication devices 410 and 412 may be ambient air, vacuum, water or other medium.

In the system 400, the diaphragms 10, 110, 210 or 310 in the first and second point to point laser communication devices 410 and 412 may realign the transmitted and/or received laser beam(s) 430 for optimal alignment on the transmitter/receiver signal coupling systems 418 and 426.

Referring now to FIG. 10, there is schematically illustrated another form of a free space communication system 500 in which one or more of the diaphragms 10, 110, 210 and 310 may be utilized. The system 500 includes a first point to point laser communication device 510 and a second point to point laser communication device 512. The first point to point laser communication device 512 includes a photodetector 514, a transmitter 516, a transmitter/receiver signal coupling system 518, a telescope 520, one of the diaphragms 10, 110, 210 and 310 described herein positioned between the transmitter/receiver signal coupling system 518 and the telescope 520, and one of the diaphragms 10, 110, 210 and 310 described herein positioned between the transmitter 516 and the transmitter/receiver signal coupling system 518.

The second point to point laser communication device 512 includes a photodetector 522, a transmitter 524, a transmitter/receiver signal coupling system 526, a telescope 528, one of the diaphragms 10, 110, 210 and 310 described herein positioned between the transmitter/receiver signal coupling system 526 and the telescope 528, and one of the diaphragms 10, 110, 210 and 310 described herein positioned between the transmitter 524 and the transmitter/receiver signal coupling system 526.

In the system 500, one or more laser beams 530 may be transmitted between the first and second point to point laser communication devices 510 and 512 to transmit information therebetween, and a propagation medium between the first and second point to point laser communication devices 510 and 512 may be ambient air, vacuum, water or other medium. In addition, the diaphragms 10, 110, 210 or 310 in the first and second point to point laser communication devices 510 and 512 positioned between the respective the transmitter/receiver signal coupling systems 518, 526 and the telescopes 520, 528 may realign the transmitted and/or received laser beam(s) 530 for optimal alignment on the transmitter/receiver signal coupling systems 518 and 518. Moreover, given the presence of the diaphragms 10, 110, 210 or 310 positioned between the respective transmitters 516, 522 and the transmitter/receiver signal coupling systems 518, 526, the system 500 is configured for independent steering of the transmitter and receiver beams. Similarly, the diaphragms 10, 110, 210 or 310 positioned between the respective transmitters 516, 522 and the transmitter/receiver signal coupling systems 518, 526 may realign and optimize the path of the laser beam(s) 530 for accurate transmittal to the other of the first and second point to point laser communication devices 510 and 512.

Another form of a free space communication system 600 in which one or more of the diaphragms 10, 110, 210 and 310 described herein may be utilized is schematically illustrated in FIG. 11. The system 600 includes a first point to point laser communication device 610 and a second point to point laser communication device 612. The first point to point laser communication device 612 includes a transceiver 614, a fiber optic cable 616, a telescope 618, and one of the diaphragms 10, 110, 210 and 310 described herein positioned between the fiber optic cable 616 and the telescope 618. The second point to point laser communication device 612 includes a transceiver 620, a fiber optic cable 622, a telescope 624, and one of the diaphragms 10, 110, 210 and 310 described herein positioned between the fiber optic cable 622 and the telescope 624.

In the system 600, one or more laser beams 630 may be transmitted between the first and second point to point laser communication devices 610 and 612 to transmit information therebetween, and a propagation medium between the first and second point to point laser communication devices 610 and 612 may be ambient air, vacuum, water or other medium.

In the system 600, the diaphragms 10, 110, 210 or 310 in the first and second point to point laser communication devices 610 and 612 may realign the transmitted and/or received laser beam(s) 630 for optimal alignment on the fiber optic cables 618, 622.

A further form of a free space communication system 700 in which one or more of the diaphragms 10, 110, 210 and 310 described herein may be utilized is schematically illustrated in FIG. 12. The system 700 includes a first point to point laser communication device 710 and a second point to point laser communication device 712. The first point to point laser communication device 710 includes a transmitter 714, a transmitter telescope 716, and one of the diaphragms 10, 110, 210 and 310 described herein positioned between the transmitter 714 and the transmitter telescope 716. The first point to point laser communication device 710 also includes a direct photodetector or fiber-based receiver system 718, a receiver telescope 720, and one of the diaphragms 10, 110, 210 and 310 described herein positioned between the fiber-based receiver system 718 and the receiver telescope 720.

The second point to point laser communication device 712 includes a transmitter 722, a transmitter telescope 724, and one of the diaphragms 10, 110, 210 and 310 described herein positioned between the transmitter 722 and the transmitter telescope 724. The second point to point laser communication device 712 also includes a direct photodetector or fiber-based receiver system 726, a receiver telescope 728, and one of the diaphragms 10, 110, 210 and 310 described herein positioned between the fiber-based receiver system 726 and the receiver telescope 728.

In the system 700, a laser beam 730 may be transmitted from the first point to point laser communication device 710 to the second point to point laser communication device 712 to transmit information therebetween, and a laser beam 732 may be transmitted from the second point to point laser communication device 712 to the first point to point laser communication device 710 to transmit information therebetween. The propagation medium between the first and second point to point laser communication devices 710 and 712 may be ambient air, vacuum, water or other medium.

In the system 700, one or both of the diaphragms 10, 110, 210 or 310 positioned between the transmitter 714 and the transmitter telescope 716 and/or the transmitter 722 and the transmitter telescope 724 could be used to perform a point ahead function where the laser beam 730 and/or 732 transmitted from a respective one or both of the first and second point to point laser communication devices 710 and 712 is sent in a slightly different direction than the light received by a respective one or both of the first and second point to point laser communication devices 710 and 712 to account for the relative movement and limited speed of light travelling through the atmosphere.

In one form, a device includes a conductive substrate; a rigid mirror positioned on a first side of the conductive substrate; a piezoelectric material positioned on a second side of the conductive substrate; and a plurality of electrodes positioned on the piezoelectric material. The conductive substrate is flexibly deformable in response to application of an electrical potential to one or more of the electrodes positioned on the piezoelectric material to move the mirror.

In one aspect of this form, the mirror is an optical-grade mirror.

In another aspect of this form, the device further includes a plurality of wires each coupled to a respective one of the plurality of electrodes.

In yet another aspect of this form, each of the plurality of electrodes is spaced from the other electrodes.

In still another aspect of this form, the conductive substrate includes one or more flexures configured to facilitate enhanced deformation of the conductive substrate in response to application of the electrical potential between different electrodes positioned on the piezoelectric material.

In this or another aspect, the one or more flexures are defined by one or more slots formed in the conductive substrate.

In another aspect of this form, the device further includes a reference electrical potential coupled to the first side of the conductive substrate.

In still another aspect of this form, the device further includes a holder coupled to the conductive substrate. The holder exhibits structural rigidity sufficient for resisting deformation when the conductive substrate is flexibly deformed in response to application of the electrical potential to one or more electrodes positioned on the piezoelectric material.

In another form, an apparatus includes a substrate; a mirror coupled to a first side of the substrate; a piezoelectric material positioned on a second side of the substrate; a number of electrodes coupled to the piezoelectric material; and an electrical driver electrically coupled to the electrodes. The mirror exhibits sufficient rigidity for resisting deformation in response to deformation of the substrate in response to application of an electrical potential from the electrical driver to one or more of the electrodes.

In one aspect of this form, the substrate is formed of a metallic material.

In this or another aspect, the apparatus further includes a number of electrical leads extending between and electrically coupling the number of electrodes and the electrical driver.

In this or another aspect, the apparatus further includes an electrode coupled to the first side of the substrate.

In another aspect of this form, in response to application of the electrical potential to the one or more electrodes, a deformation occurs in the piezoelectric material.

In still another aspect of this form, the apparatus further includes a holder coupled to the substrate. The holder exhibits structural rigidity sufficient for resisting deformation in response to application of the electrical potential to the one or more electrodes coupled to the second side of the substrate.

In another aspect of this form, the electrical driver is configured to selectively apply the electrical potential to a number of different combinations of the one or more electrodes and the mirror is movable in one or more of a plurality of directions dependent on the combination of the one or more electrodes to which the electrical potential is applied.

In yet another aspect of this form, the substrate includes one or more flexures configured to facilitate enhanced deformation of the substrate in response to application of the electrical potential to the one or more electrodes.

In another form, a method includes providing a device including a conductive substrate having a first configuration, a mirror coupled to a first side of the conductive substrate and having a first configuration, and a number of electrodes coupled to a second side of the conductive substrate. The method further includes applying an electrical potential to one or more of the electrodes coupled to the second side of the conductive substrate to deform the conductive substrate relative to the first configuration of the conductive substrate and move the mirror while maintaining the mirror in the first configuration of the mirror.

In one aspect of this form, the electrical potential is applied to two or more of the electrodes coupled to the second side of the conductive substrate and the mirror is moved in two or more directions.

In this or another aspect, the method also includes coupling the conductive substrate to a holder configured to resist deformation when the conductive substrate is deformed in response to application of the electrical potential.

In another aspect of this form, maintaining the mirror in the first configuration includes maintaining flatness of a surface of the mirror.

Unless specific arrangements described herein are mutually exclusive with one another, the various implementations described herein can be combined to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be 10 embraced within their scope.

What is claimed is:

1. A device, comprising:
a conductive substrate;
a rigid mirror positioned on a first side of the conductive substrate;
a piezoelectric material positioned on a second side of the conductive substrate; and
a plurality of electrodes positioned on the piezoelectric material;
wherein the conductive substrate is flexibly deformable in response to application of an electrical potential to one or more of the electrodes positioned on the piezoelectric material to move the mirror.

2. The device of claim 1, wherein the mirror is an optical-grade mirror.

3. The device of claim 1, further comprising a plurality of wires each coupled to a respective one of the plurality of electrodes.

4. The device of claim 1, wherein each of the plurality of electrodes is spaced from the other electrodes.

5. The device of claim 1, wherein the conductive substrate includes one or more flexures configured to facilitate enhanced deformation of the conductive substrate in response to application of the electrical potential between different electrodes positioned on the piezoelectric material.

6. The device of claim 5, wherein the one or more flexures are defined by one or more slots formed in the conductive substrate.

7. The device of claim 1, further comprising a reference electrical potential coupled to the first side of the conductive substrate.

8. The device of claim 1, further comprising a holder coupled to the conductive substrate, wherein the holder exhibits structural rigidity sufficient for resisting deformation when the conductive substrate is flexibly deformable in response to application of the electrical potential to one or more electrodes positioned on the piezoelectric material.

9. An apparatus, comprising:
a substrate;
a mirror coupled to a first side of the substrate;
a piezoelectric material positioned on a second side of the substrate;
a number of electrodes coupled to the piezoelectric material; and
an electrical driver electrically coupled to the electrodes;
wherein the mirror exhibits sufficient rigidity for resisting deformation in response to deformation of the substrate in response to application of an electrical potential from the electrical driver to one or more of the electrodes.

10. The apparatus of claim 9, wherein the substrate is formed of a metallic material.

11. The apparatus of claim 10, further comprising a number of electrical leads extending between and electrically coupling the number of electrodes and the electrical driver.

12. The apparatus of claim 11, further comprising an electrode coupled to the first side of the substrate.

13. The apparatus of claim 9, wherein, in response to application of the electrical potential to the one or more electrodes, a deformation occurs in the piezoelectric material.

14. The apparatus of claim 9, further comprising a holder coupled to the substrate, wherein the holder exhibits structural rigidity sufficient for resisting deformation in response to application of the electrical potential to the one or more electrodes coupled to the second side of the substrate.

15. The apparatus of claim 9, wherein the electrical driver is configured to selectively apply the electrical potential to a number of different combinations of the one or more electrodes and the mirror is movable in one or more of a plurality of directions dependent on the combination of the one or more electrodes to which the electrical potential is applied.

16. The apparatus of claim 9, wherein the substrate includes one or more flexures configured to facilitate enhanced deformation of the substrate in response to application of the electrical potential to the one or more electrodes.

17. A method, comprising:
providing a device including a conductive substrate having a first configuration, a mirror coupled to a first side of the conductive substrate and having a first configuration, and a number of electrodes coupled to a second side of the conductive substrate; and
applying an electrical potential to one or more of the electrodes coupled to the second side of the conductive substrate to deform the conductive substrate relative to the first configuration of the conductive substrate and move the mirror while maintaining the mirror in the first configuration of the mirror.

18. The method of claim 17, wherein the electrical potential is applied to two or more of the electrodes coupled to the second side of the conductive substrate and the mirror is moved in two or more directions.

19. The method of claim 18, further comprising coupling the conductive substrate to a holder configured to resist deformation when the conductive substrate is deformed in response to application of the electrical potential.

20. The method of claim 17, wherein maintaining the mirror in the first configuration includes maintaining flatness of a surface of the mirror.
